(19) United States
(12) Patent Application Publication
(10) Pub. No.: US 2012/0101646 A1
(43) Pub. Date: Apr. 26, 2012

(54) INTERACTIVE SYSTEM FOR PRICE-POINT CONTROL OF POWER CONSUMPTION

(76) Inventors: Neil K. Nydegger, Rancho Santa Fe, CA (US); James Eric Taylor, El Centro, CA (US)

(21) Appl. No.: 12/908,721

(22) Filed: Oct. 20, 2010

(51) Int. Cl. G05B 15/02

(52) U.S. Cl. 700/291

(57) ABSTRACT

A system and method for controlling energy consumption at a facility requires categorizing operational devices at the facility into first and second groups, and prioritizing them within the group according to their energy demand requirements. A meter is provided for monitoring an actual real-time energy consumption for each device at the facility, and a totalizer is connected to the meter for measuring a total Energy Consumption Level (ECL) for all devices. A computer/controller is provided for comparing the total ECL with a first price-point (PP₁) and with a second price-point (PP₂). In operation, the computer/controller implements a prioritized shut down of operational devices in the first group whenever a cost for the total ECL exceeds the first price-point (PP₁), and a prioritized shut down of operational devices in the second group whenever a cost for the total ECL exceeds the second price-point (PP₂).

### FIELD OF THE INVENTION

The present invention pertains generally to systems and methods for monitoring and controlling the cost of power consumption at a facility. More particularly, the present invention pertains to systems and methods that provide for the automatic control of power consumption by operational devices at a particular facility, in accordance with parameters selected by the consumer. The present invention is particularly, but not exclusively, useful as a system and method for cost control of power consumption, wherein the selective shut down of devices at a facility is accomplished based on price-point information, as the information is received in real-time, from an Independent System Operator (ISO).

### BACKGROUND OF THE INVENTION

Electrical power consumption is costly, but also necessary. As is well appreciated, electrical power is used in some manner, by almost everyone, every day. As typically happens, there are times during a day when electrical power consumption peaks. At other times, however, there may be very little demand for electrical power. Consequently, the price for power will fluctuate over a fairly large range during a 24-hour period. In line with these fluctuations, there are several Independent System Operators (ISOs) within the United States that set a price-point for power consumption based primarily on power demand considerations. Importantly, in real-time, the price-point will literally change from minute-to-minute. As a consequence, the price for electrical power that is set by an ISO may be quite high during periods of peak power usage, and quite low at other times. Further, it can happen that an ISO will actually pay a consumer to use power during certain off-peak hours.

Within a particular facility (e.g. a home) there are most likely several different types of operational devices that consume electrical power. Some, of course, will consume more electrical power than others. For example, air conditioners (heating and cooling), along with pool pumps, have greater power requirements than do lights, radios, TVs and many other relatively small appliances. Further, some of the relatively larger appliances (e.g. water heaters) are able to store heat when they are turned off, while others (e.g. deep-freezers) can remain cold for extended periods of time even though they may also be turned off. In sum, power consumption by the various operational devices within a facility can vary greatly. Importantly, these variations will occur cyclically in a manner that is best known only by the consumer (i.e. the individual that controls the operational devices and pays for the bills).

Heretofore, efforts have been made to control power consumption by encouraging consumers to shift the use of their high demand operational device to off-peak hours of operation. The efficacy of these efforts, however, has been generally problematic. This is so because consumers do not always appreciate when there are periods of peak operation. Moreover, they can not fully appreciate how long these periods will last, or how much the power grid may be overloaded during these peak operations periods. What the consumer does know, however, is how much he/she is willing to pay for his/her use of operational devices, and which operational devices he/she wants to remain operational.

In light of the above, it is an object of the present invention to provide a system and method for monitoring and controlling the cost of power consumption at a facility (e.g. a home). Another object of the present invention is to provide for automatic control over the power consumption of operational devices at a particular facility, in accordance with parameters selected by the consumer. Still another object of the present invention is to control the cost of power consumption at a facility by selectively shutting down devices based on price-point information, as this information is received in real-time, from an Independent System Operator (ISO). Yet another object of the present invention is to provide a system and method for monitoring and controlling the cost of power consumption at a particular facility that is easy to use, is relatively simple to manufacture and install and is comparatively cost effective.

### SUMMARY OF THE INVENTION

In accordance with the present invention, a system and method are provided for controlling the collective energy consumption of a plurality of operational devices at a particular facility (e.g. a home). In particular, this control requires continuously monitoring the cost of power consumption by the facility. For the present invention, this is done in real-time, and the consequent power consumption is controlled with reference to a price-point for the power demand of the facility. Importantly, this price-point is established by the Independent System Operator (ISO) that is providing power to the facility from the regional power grid. Based on the cost of this power (determined by the ISO price-point), and on the historical power consumption requirements of the facility (known by the facility owner/consumer), an operational regimen is established for power consumption by operational devices at the facility.

Initially, operational devices at the facility are categorized, by the consumer, into a first group and a second group. Additional groups can be used, if desired. The operational devices are then prioritized within each group by the consumer according to both their functional utility and their energy demand requirements. Once they are categorized and prioritized, the identity of each individual operational device is input to a meter. In the system, this meter is individually connected to each of the operational devices, and it is used to monitor the actual real-time energy consumption of each operational device. This information is then fed from the meter to a totalizer which measures a total Energy Consumption Level (ECL) for the plurality of operational devices.

In addition to the meter and totalizer, the system of the present invention also includes a computer/controller. Input for the operation of this computer/controller comes from the consumer, from the ISO, and from the facility. Input to the computer/controller from the consumer includes operational parameters for each of the respective operational devices at the facility. This input also includes the category (group) and priority of each operational device within its group. Input to the computer/controller from the ISO essentially includes pricing information. Importantly, this pricing information is the instantaneous price-point for energy, as established by the pertinent ISO. And, input to the computer/controller from the facility is the instantaneous ECL, as it is being measured by the totalizer. Structurally, the computer/controller is electronically connected indirectly to each individual operational device through the meter and, as disclosed below, the computer/controller will selectively shut down, or re-activate, each operational device according to a protocol that is established by the consumer.

As indicated above, all of the operational devices are categorized and prioritized. For these purposes, all of the operational devices are first identified by the consumer according to their particular energy demand requirements. In descending order of energy consumption, the demand requirements of operational devices can generally be identified as being:
“A” devices having high-demand energy requirements;
“B” devices having intermittent-demand energy requirements; and
“C” devices having marginal-demand energy requirements.
   In general, using the above identifiers, the first group of operational devices will include the “B” and “C” devices. Within this first group, the operationally functional “C” devices and operationally functional “B” devices are considered, in this order, for sequential shut down. The second group of operational devices will then include the “A” devices. It is to be appreciated that the categorization of an operational device into either a first or second group, as well as its identification as an “A”, “B” or “C” device, and all priorities for devices within a group are established at the sole discretion of the consumer. In each case, however, the objective is to maintain overall operation (i.e. ECL) under an established price-point.

For an operation of the present invention, the consumer sets a first price-point (PP₁), and a second price-point (PP₂), in the computer/controller. Operationally, PP₁ will be less than PP₂. Note: it is the consumer that sets both PP₁ and PP₂ for the computer/controller, not the ISO. As noted above, the total ECL is also continuously obtained by the computer/controller from the meter and the totalizer. Thus, the computer portion of the computer/controller can compare the total ECL with the first price-point (PP₁) and with the second price-point (PP₂), on a real-time basis.

A controller portion that is responsive to the computer portion of the computer/controller will implement a prioritized shut down of operational devices in the first group whenever a cost for the total ECL exceeds the first price-point (PP₁). As a practical matter, this shut down of devices in the first group will be iterative. Recall, most likely, “C” devices will be the first to be shut down, followed by “B” devices. In any event, when a proper shut down of all devices in the first group has been accomplished, and the ECL again goes above PP₁, the controller will then begin to implement a prioritized shut down of operational devices in the second group. Specifically, this will be done whenever a cost for the total ECL exceeds the previously established second price-point (PP₂).

In accordance with the particular protocol that is programmed by the consumer, it can happen that “B” devices may only be shut down for a respective predetermined time interval. If so, according to the protocol, they may be automatically re-activated at the end of the time interval, or at another time determined by the consumer. It can also happen that “C” devices may be selectively turned on when the total ECL is between PP₁ and PP₂, so long as PP₂ is not exceeded. Further, as a precaution, the consumer may elect to have a selective turn-on (re-activation) of “A” and “B” devices, if doing so will not cause the total ECL to exceed PP₁.

### BRIEF DESCRIPTION OF THE DRAWINGS

The novel features of this invention, as well as the invention itself, both as to its structure and its operation, will be best understood from the accompanying drawings, taken in conjunction with the accompanying description, in which similar reference characters refer to similar parts, and in which:

FIG. 1 is a schematic diagram of a system for the present invention;

FIG. 2 is an exemplary time graph of energy consumption for operational devices at a facility in comparison with price-point settings; and

FIG. 3 is a logic flow chart for an operation of the present invention.

### DESCRIPTION OF THE PREFERRED EMBODIMENTS

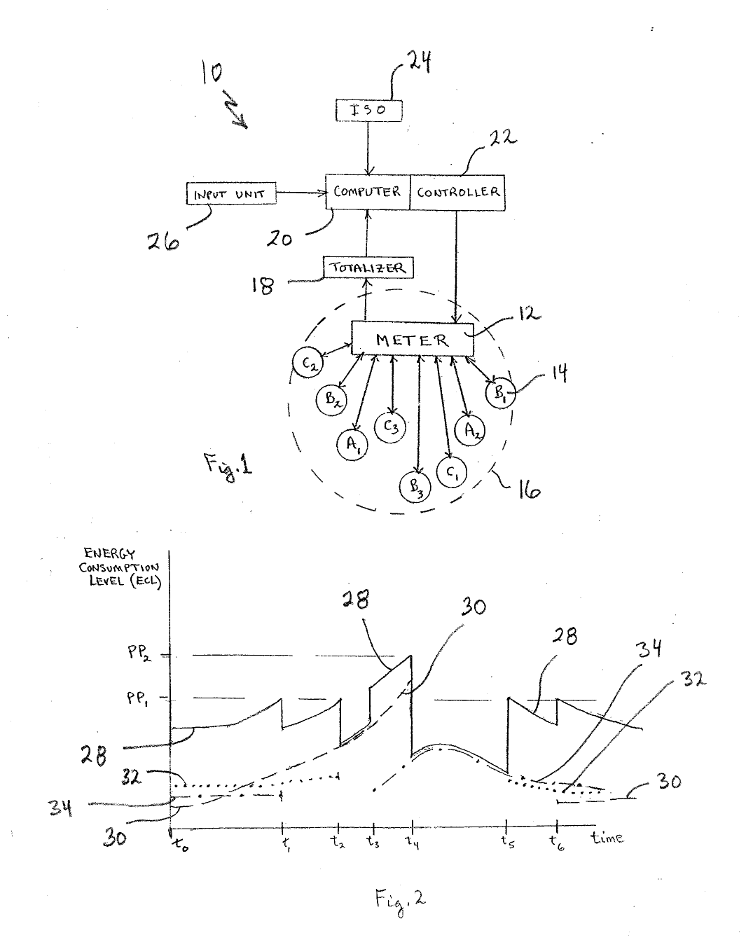

Referring initially to FIG. 1, a system in accordance with the present invention is shown and is generally designated 10. As shown, the system 10 includes a meter 12 and a plurality of devices 14 that are each, individually, connected electronically to the meter 12. Further, FIG. 1 shows that all of the devices 14 are located at a facility 16. As envisioned for the present invention, the facility 16 may be a home, an office building, a public venue or any other type edifice or location having a common electric bill. For purposes of disclosure, each operational device 14 at the facility 16 is identified with a letter and a subscript. As used here, the letter for a device 14 (i.e. “A”, “B” and “C”) is used to identify the general energy demand of the device 14. Specifically,
“A” devices 14 have high-demand energy requirements;
“B” devices 14 have intermittent-demand energy requirements; and
“C” devices 14 have marginal-demand energy requirements.
   The subscripts are then used to distinguish different devices 14. For example, both the “C₁” and “C₃” devices 14 have generally the same marginal-demand energy requirements, though they are separate and may be different from each other.

In greater detail, examples of “A” devices 14 (i.e. high demand) include such things as heating and air-conditioning units, as well as pool pumps. Generally, “A” type devices 14 likely will be operational for extended periods of time. Examples of “B” devices 14 (i.e. intermittent demand) are items such as water heaters and deep freezers that may be shut down for defined periods of time, without adversely compromising their overall operational efficiency. On the other hand, “C” devices 14 (i.e. marginal demand) are items such as lights, radios, TVs and other small appliances that are frequently turned OFF and ON for relatively short periods of time.

Still referring to FIG. 1, as used for the system 10, the meter 12 measures the electrical power consumption of each device 14 as it is being operated at the facility 16. These measurements are then forwarded to a totalizer 18 where they are summed and used as input to a computer 20. Consequently, at any time of day, the computer 20 receives an input signal from the meter 12 that is indicative of the instantaneous Energy Consumption Level (ECL) for all of the currently operating devices 14 at the facility 16. As also shown, the computer 20 is operationally connected with a controller 22. For disclosure purposes, this combination will hereinafter sometimes be referred to as the computer/controller 20/22. Further, FIG. 1 shows that the controller 22 of computer/controller 20/22 is electronically connected through the meter 12 to each of the operational devices 14. Specifically, through the connection of the computer/controller 20/22 with the individual operational devices 14, the controller 22 is able to selectively shut down (i.e. turn OFF) and reactivate (i.e. turn ON) each individual operational device 14.

In addition to input from the meter 12 and totalizer 18 (i.e. ECL), the computer 20 also receives input from an Independent System Operator (ISO) 24. As is well known, there are several ISOs 24 that monitor power usage in various regional power grids throughout the United States. Importantly, each ISO 24 provides an instantaneous value for the cost of power within the particular grid. This instantaneous value is commonly known as a “price-point”, and it is continuously available for public information and use. As envisioned for the system 10, it is the instantaneous “price-point” from the ISO 24 that is used as input to the computer 20. It will be appreciated, however, that entities other than an ISO 24 can perform the same function without departing from the purposes of the present invention. In the event, a “price-point,” regardless of its source, is a key informational input for the system 10.

Along with ECL information from the meter 12, and the “price-point” information from the ISO 24, the computer 20 will also receive information from an input unit 26. Specifically, this input information includes parameters for the operation of various devices 14 at the facility 16. These parameters are provided by a user/consumer (not shown), and are used to program the computer/controller 20/22 for an operation of the system 10. These parameters include: i) an operational identification for each device 14 [e.g. “A”, “B” or “C”]; ii) prioritization of the identified devices 14 [e.g. subscripts “A₁” and “A₂”]; iii) “price-point” settings [e.g. a first Price-Point (PP₁), and a second Price-Point (PP₂)]; and iv) categorization of the devices 14 into groups that are respectively responsive to different price-points. Further, as will be appreciated by the skilled artisan, at least one operational device may be categorized into a third group. The ECL is then compared with a third price-point (PP₃) for the shutdown of devices in the third group. If used, PP₃ will be greater than PP₂.

By way of example, a user/consumer will first identify a particular device 14 according to its energy demand requirements (“A”, “B”, or “C”). Next, all devices 14 with a same identifier (e.g. “C”) are prioritized according to their functional utility (e.g. “C₁”, “C₂” and “C₃”). Finally, the prioritized devices 14 are categorized into groups according to a particular “price-point” that is established by the user/consumer. For instance, with this categorization, a first group may include both “B” and “C” type devices 14 that will be responsive to a first price-point, PP₁. A second group may then include only “A” type devices that are responsive to a second price-point, PP₂. As will be appreciated by the skilled artisan, the prioritization and categorization of devices 14 are somewhat arbitrary and are established at the sole discretion of the user/consumer. In the context of system 10, it is important to recall that the computer 20 receives this input of the operational parameters from input unit 26, together with the ECL from meter 12, and the instantaneous price-point from ISO 24.

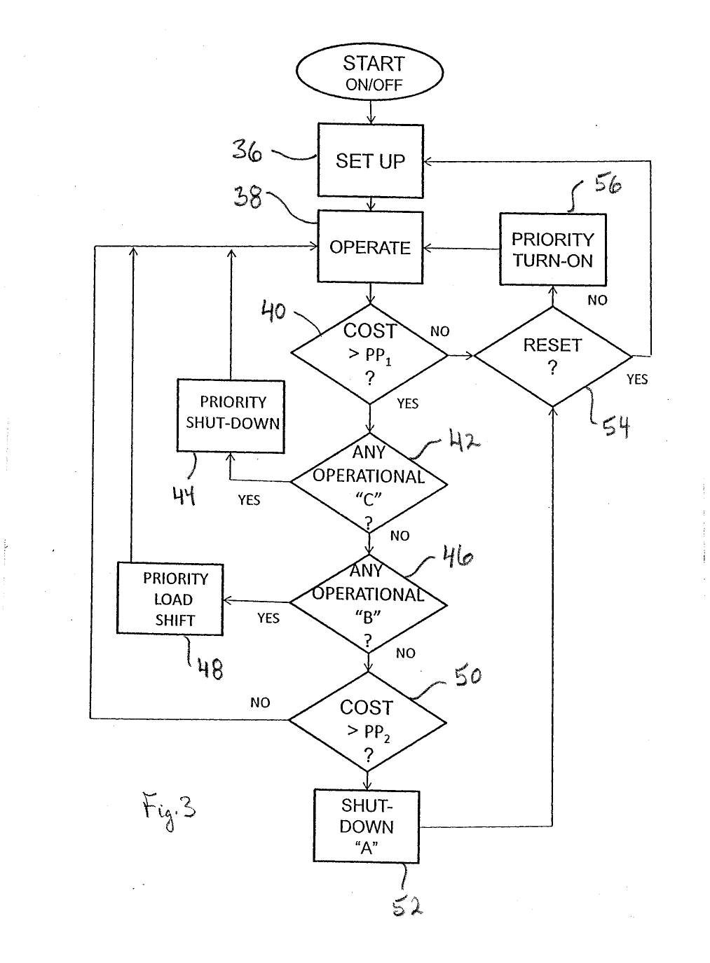

For an operation of the system 10, it may be helpful to simultaneously reference both FIG. 2 and FIG. 3. Before doing so, however, it is necessary to first appreciate what is depicted in the time graph of FIG. 2. In FIG. 2, the solid line 28 represents the total ECL of all operational devices 14 at the facility 16. This total ECL (i.e. solid line 28) does not account for the identity of a particular device 14 as being either an “A”, “B”, or “C” type device 14. Components of the total ECL (i.e. solid line 28), however, are also depicted according to the type of the device 14. In particular, the dashed line 30 represents energy consumption by “A” type devices. The dotted line 32 represents energy consumption by “B” type devices. And, the dot-dash line 34 represents energy consumption by “C” type devices. These lines 30, 32, and 34 are only exemplary. FIG. 2 also shows a first price-point (PP₁) and a second price-point (PP₂) on the vertical axis. As mentioned above, PP₁ and PP₂ are established by the user/consumer. For purposes of disclosure, the time graph of FIG. 2 is considered exemplary of a typical 24 hour period of a summer day. Also, the operational devices 14 are considered to be categorized into a first group (e.g. “B” and “C” devices) that is responsive to PP₁, and a second group (e.g. “A” devices) that is responsive to PP₂. Note: for the identity of devices 14 as set forth in this disclosure, PP₂ will typically, but not necessarily, be greater than PP₁.

For the operation of the system 10, and as indicated at the “set up” block 36 in FIG. 3, a user/consumer manipulates the input unit 26 to provide operational parameters for the computer/controller 20/22. Once the operational parameters have been input to the computer/controller 20/22, and after the computer/controller 20/22 has been properly connected to the meter 12 and to the ISO 24, the “operate” block 38 in FIG. 3 begins an operation of the system 10 at a time “t₀”. Note in FIG. 2 that for the example being given, at least one of all three type devices (“A”, “B”, and “C”) are operational.

At time “t₀”, the inquiry block 40 in FIG. 3 causes the system 10 to begin comparing the ECL with the first price-point PP₁ to determine an ECL operational limit. It is important to realize that between time “t₀” and time “t₁” the “price-point” provided by ISO 24 is shown to be increasing. At a time “t₁”, when the “price-point” increase has caused the ECL to equal PP₁, block 44 indicates the beginning of a priority shut down of type “C” operational devices 14. As will be appreciated by the skilled artisan, because the “price-point” set by ISO 24 will likely continue to increase, this priority shut down most likely will be iterative (i.e. there may be successive shut downs and “t₁” may actually represent several successive different times). In any event, the priority shut down of type “C” devices 14 will continue until all appropriately prioritized type “C” devices 14 have been shut down (see inquiry block 42).

With all type “C” devices 14 shut down, and with a still increasing price-point from the ISO 24, inquiry block 46 indicates that system 10 will begin considering type “B” devices 14. Note: in this example the first price-point PP₁ is still operative in the time interval between “t₁” and “t₂”. Further, during the time interval between “t₁” and “t₂”, block 48 indicates the possibility of a load shift. As envisioned for the present invention, “load shift” means that the particular device 14 (e.g. a water heater) may be shut down for only a predetermined time interval, and then reactivated. Alternatively, rather than having a load shift, the system 10 may simply execute a shut down. In either event, at time “t₂” when all of the “B” and “C” type devices 14 have been shut down, the system 10 then shifts to a use of the second price-point PP₂ as the ECL operational limit. In this example, at time “t₂” the price-point provided by ISO 24 is still increasing.

After time “t₃”, when both the “B” and “C” type devices have been shut down, it may be possible to turn on some of the lower power consuming, prioritized “C” type devices 14. Operationally, however, at time “t₄” when the total ECL reaches PP₂, inquiry block 50 in FIG. 3 indicates that the system 10 begins to shut down the “A” type devices (see block 52). Again, this shut down may be iterative. It is now assumed, and indicated in FIG. 2, that at sometime between “t₄” and “t₅”, the price-point established by ISO 24 will begin to decrease. Consequently, during the time interval between “t₄” and “t₅”, and thereafter, inquiry block 54 indicates that system 10 is prepared for either a prioritized turn on (block 56) of operational devices 14 (e.g. at a time “t₆” in FIG. 3) or a complete reset of all devices 14 wherein all of the devices 14 are returned to their condition at time “t₀”.

While the particular Interactive System for Price-Point Control of Power Consumption as herein shown and disclosed in detail is fully capable of obtaining the objects and providing the advantages herein before stated, it is to be understood that it is merely illustrative of the presently preferred embodiments of the invention and that no limitations are intended to the details of construction or design herein shown other than as described in the appended claims.

What is claimed is:

1. A system for controlling the collective energy consumption by a plurality of operational devices, wherein the operational devices are categorized into a first group and a second group, and are prioritized according to their functional utility and their energy demand requirements, the system comprising:
a meter for monitoring an actual real-time energy consumption for each operational device;
a totalizer connected to the meter for measuring, in real-time, a total Energy Consumption Level (ECL) for the plurality of operational devices;
a computer for comparing the total ECL with a first price-point (PP₁) and with a second price-point (PP₂), wherein PP₁ is less than PP₂;
an input unit connected to the meter to establish respective operational parameters for each of the operational devices; and
a controller, responsive to the computer for implementing a prioritized shut down of operational devices in the first group whenever a cost for the total ECL exceeds the first price-point (PP₁), and for implementing a prioritized shut down of operational devices in the second group whenever a cost for the total ECL exceeds the second price-point (PP₂).

2. A system as recited in claim 1 wherein, in descending order of energy demand requirements, the operational devices comprise:
“A” devices having high-demand energy requirements;
“B” devices having intermittent-demand energy requirements; and
“C” devices having marginal-demand energy requirements.

3. A system as recited in claim 2 wherein the first group of operational devices includes “B” and “C” devices, and the second group of operational devices includes “A” devices.

4. A system as recited in claim 3 wherein operationally functional “C” devices and operationally functional “B” devices are considered, in this order, for sequential shut down.

5. A system as recited in claim 4 wherein “B” devices are shut down for a respective predetermined time interval, and are subsequently automatically re-activated.

6. A system as recited in claim 3 wherein at least one operational device is categorized into a third group, and the ECL is compared with a third price-point (PP₃) for the shutdown of devices in the third group, and wherein PP₃ is greater than PP₂.

7. A system as recited in claim 3 wherein “C” devices are selectively turned on when the total ECL is between PP₁ and PP₂.

8. A system as recited in claim 7 wherein a selective turn-on of “A” and “B” devices will not cause the total ECL to exceed PP₁.

9. A system for controlling the collective energy consumption by a plurality of operational devices, wherein the operational devices are categorized into a first group and a second group, and are prioritized according to their functional utility and their energy demand requirements, the system comprising:
a totalizer electronically connected with the plurality of operational devices for measuring, in real-time, a total Energy Consumption Level (ECL) for the plurality of operational devices;
a computer preprogrammed with a plurality of preset price-points; and
a controller, responsive to the computer for implementing a prioritized shut down of operational devices in the first group whenever a cost for the ECL exceeds a first price-point (PP₁), and for implementing a prioritized shut down of operational devices in the second group whenever a cost for the ECL exceeds a second price-point (PP₂), wherein PP₁ is less than PP₂.

10. A system as recited in claim 9 further comprising:
a meter for monitoring an actual real-time energy consumption for each operational device, wherein the meter is connected to the totalizer; and
an input unit connected to the computer to establish respective operational parameters for each of the operational devices.

11. A system as recited in claim 9 wherein, in descending order of energy demand requirements, the operational devices comprise:
“A” devices having high-demand energy requirements;
“B” devices having intermittent-demand energy requirements; and
“C” devices having marginal-demand energy requirements, wherein the first group of operational devices includes “B” and “C” devices, and the second group of operational devices includes “A” devices.

12. A system as recited in claim 9 wherein at least one operational device is categorized into a third group, and the ECL is compared with a third price-point (PP₃) for the shutdown of devices in the third group, and wherein PP₃ is greater than PP₂.

13. A system as recited in claim 9 wherein “C” devices are selectively turned on when the total ECL is between PP₁ and PP₂.

14. A system as recited in claim 13 wherein a selective turn-on of “A” and “B” devices will not cause the total ECL to exceed PP₁.

15. A method for controlling the collective energy consumption by a plurality of operational devices which comprises the steps of:
categorizing the operational devices into a first group and a second group;
prioritizing the operational devices according to their functional utility and their energy demand requirements;
monitoring an actual real-time energy consumption for each operational device;
measuring, in real-time, a total Energy Consumption Level (ECL) for the plurality of operational devices;
establishing a first price-point (PP₁) and a second price-point (PP₂), wherein PP₁ is less than PP₂;
comparing the total ECL with the first price-point (PP₁) and with the second price-point (PP₂); and
implementing a prioritized shut down of operational devices in the first group whenever a cost for the total ECL exceeds the first price-point (PP₁), and implementing a prioritized shut down of operational devices in the second group whenever a cost for the total ECL exceeds the second price-point (PP₂).

16. A method as recited in claim 15 wherein the prioritizing step is accomplished by identifying “A” devices having high-demand energy requirements, “B” devices having intermittent-demand energy requirements, and “C” devices having marginal-demand energy requirements; and wherein the categorizing step is accomplished by placing “B” and “C” devices in the first group of operational devices, and by placing “A” devices in the second group of operational devices.

17. A method as recited in claim 16 wherein “C” devices are selectively turned on when the total ECL is between PP₁ and PP₂.

18. A method as recited in claim 17 wherein a selective turn-on of “A” and “B” devices will not cause the total ECL to exceed PP₁.

19. A method as recited in claim 15 wherein at least one operational device is categorized into a third group, and the ECL is compared with a third price-point (PP₃) for the shutdown of devices in the third group, and wherein PP₃ is greater than PP₂.

20. A method as recited in claim 15 further comprising the step of resetting the plurality of operational devices when a selective turn-on of “A” and “B” devices will not cause the total ECL to exceed PP₁.
